(19) United States
(12) Patent Application Publication
(10) Pub. No.: US 2010/0087009 A1
(43) Pub. Date: Apr. 8, 2010

(54) Method for automated formulation process for production of radiopharmaceutical injection medicine and evaluation thereof

(76) Inventors: MING-HSIN LI, Taoyuan County (TW); Wuu-Jyh Lin, Taoyuan County (TW)

Correspondence Address: MICHAEL LIN, 5F 79 Roosevelt Rd. Sec. 2, TAIPEI, 106, TW

(21) Appl. No.: 12/246,503

(22) Filed: Oct. 7, 2008

(51) Int. Cl. G01N 31/22; G06F 19/00

(52) U.S. Cl. 436/163; 702/19

(57) ABSTRACT

A method of automated formulation process for radiopharmaceutical injection medicine, including preparation for process control and calculation for formulation control, wherein the preparation steps for process control includes measuring radioactivity and size of radiopharmaceutical materials, determining measurement time and calibration time, measuring pH value and impurity percentage of radiopharmaceutical raw materials. By means of input of parameters measured and calculation of the volume of injection solvent and pH value, finished product of injection medicine is obtained when the pH value reaches 6.5, and the finished product is dispensed into the sterile bottles.

### BACKGROUND OF THE INVENTION

1. Field of the Invention

The present invention relates to a method of automated formulation process for production of radiopharmaceutical injection medicine and evaluation. More particularly, the present invention relates to a method including preparation steps for process control and calculation parameters for determining the formulation of medicine.

2. Description of the Prior Art

In conventional way, an extracted radioactive dose was directly dispensed with saline or injection solvent without considering the pH value or the isotonic of injection dose, as a result, it will cause painful or uncomfortable for human body after receiving the injection.

Also, the radioactive dose is dispensed directly after the measurement of radioactivity without taking consideration of the contribution of impurities in the dose. Due to shorter period of half-life of impurities, the content of radiopharmaceutical injection dose may shift from its normal value. As a result, the insufficiency of the dose will be detected during calibration.

### SUMMARY OF THE INVENTION

One object of the present invention is to provide a method for solving the problem due to uncontrolled pH value and isotonic solution. The other object of the present invention is to provide a method for solving the problem with uncontrolled percentage of impurities contained in radioactive dose.

For these two objects, a method of automated formulation process for production of radiopharmaceutical injection medicine and evaluation of the present invention comprises the following steps: a) preparation steps of process control and measurements of parameters; b) calculation of parameters for formulation control to obtain the volume of dispensing solvent and the pH value of finished product.

a) Preparation Steps of Process Control and Measurements of Parameters:
1. Measuring the radioactivity of radiopharmaceutical material (radioactive solution, for example, TlCl [Tl-201]) (Aₒ)_mCi;
2. Measuring volume (Vₒ)_mL of radiopharmaceutical material;
3. Time of measurement (Tm): _Y_M_D_H;
4. Schedule of calibration for radioactivity of radiopharmaceutical injection (Tc): _Y M_D_H;
5. Measuring the pH value of radiopharmaceutical material;
6. Measuring the percentage of impurities in radioactive nuclide.

After measuring and inputting parameters, it takes Tl-201 radioactive nuclide as an example to show the calculation in the following steps.

b) Calculation of Parameters for Formulation Control:
1. Calculating the coefficient X, Y, and F that are needed for preparation in the process:
   X=EXP(−(LN(2)/73.5)*(Tc-Tm));
   X indicates the coefficient of radioactive nuclide attenuation;
   Tc indicates the calibration time;
   Tm indicates the measurement time.
2. The volume of benzyl alcohol preparation solvent is V_{b}_{_{—}}mL.
3. The volume of saline preparation solvent is Vₙ_{_{—}}mL.
4. The volume of injection preparation solvent is Vⱼ_{_{—}}mL.
5. The total volume of preparation solvent is V_{f}_{_{—}}mL.
6. Calculating the pH value of the product mixed in the process of formulation.
7. Calculating the pH value of the product mixed with the following formula:

X=e^{-λ}^{₂}¹ (1)

wherein,

$${λ}_{2} = ln 2 \frac{1}{{t}_{1 / 2}} ;$$

t½ expresses the half-life of the radioactive nuclide;

$$\begin{matrix}A ( t ) = A ( 0 ) * {e}^{- λ 2 t} * F & ( 2 ) \\ F = ( R * {f}_{1} * {e}^{- ( {λ}_{2} - {λ}_{1} ) t} + {f}_{2} ( \frac{1}{R * {f}_{1} + {f}_{2}} ) & ( 3 )\end{matrix}$$

f₁,f₂ are the fraction of activity which indicates the percentage of main nuclide and impurity nuclide;
λ₁,λ₂ indicates the decay constant of individual nuclide of main nuclide and the impurity nuclide;
F expresses the correction function of impurity nuclide;
R expresses the expansion multiple of decayed nuclide, and according to the experiment report INER-T2484 of Institute of Nuclear Energy Research, the coefficient of R is determined with type of nuclide.

Take the calculating result obtained from formula mentioned above to the following formulas and calculate the volume of preparation solvent:

Vf=(A₀*Coefficient F/Coefficient Y)*6−0.99*Vₒ (4)

wherein Y=Predetermined activity intensity of each bottle of injection needed/X=The activity of each bottle of injection at calibration time (Tc)

Vb=(0.99*Vₒ+Vf)*0.009 (5)

Vn=(0.99*Vₒ+Vf)*0.8333 (6)

Vj=Vf−Vb−Vn (7)

The automated formulation process for production and evaluation of the radiopharmaceutical injection medicine of the present invention can be simplified to the steps as follows:
1. Extracting the radioactive nuclide solvent, measuring its radioactivity (Aₒ), volume of materials (Vₒ), pH value of the radiopharmaceutical materials, and recording measurement time and calibration time of the radioactivity of the radiopharmaceutical injection (Tc), and percentage of impurities in radioactive nuclide,
2. After inputting and recording the coefficients fore mentioned, calculating the relative data for formulation control including: the volumes of benzyl alcohol (V_{b}), saline (Vn), and injection solvent (Vj).
3. Extracting the volume according to the data calculated for Vb`Vn`Vj.
4. Mixing and preparing the radioactive nuclide solvent Vₒ and the solvent of the calculated data (Vb`Vn`Vj).
5. Calculating total volume of the dispensing solvent Vf and the pH value of mixture produced by formulation.
6. Dispensing the mixture solvent into each sterile bottle.

### BRIEF DESCRIPTION OF THE DRAWINGS

FIG. 1 is a block diagram indicates radiopharmaceutical injection medicine production line of the present invention; and

FIG. 2 is a block diagram indicates automated formulation process of the present invention.

### DETAILED DESCRIPTION OF THE PREFERRED EMBODIMENT

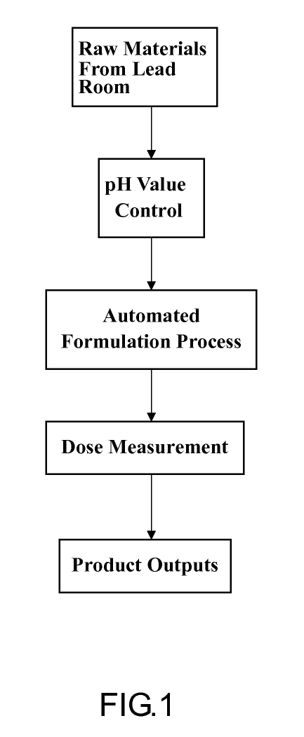

In FIG. 1, a block diagram indicates radiopharmaceutical injection medicine production line of the present invention; after calculating the relative parameter and evaluating radiopharmaceutical injection formulation through the automated formulation process of the present invention, the finished product is delivered to autoclave for disinfection and then dispensed into the non-bacteria bottles.

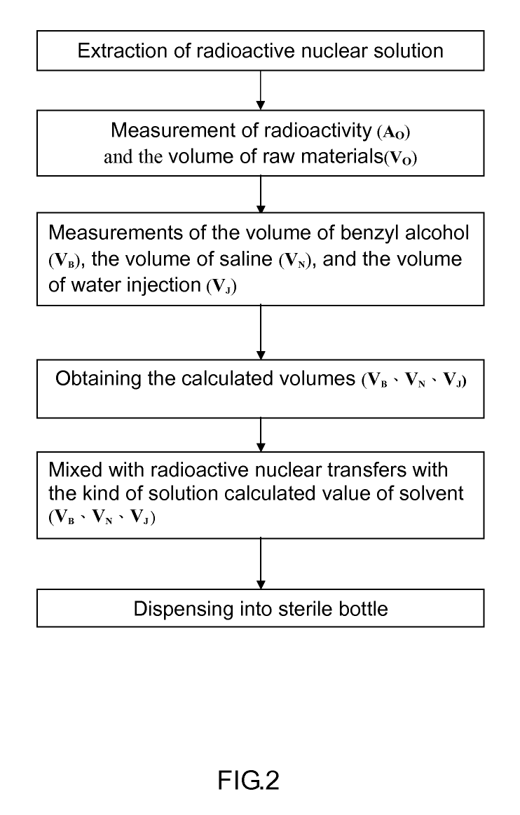

In FIG. 2, the present invention provides a new evaluation system, a parameter survey system, which can be used to calculate the contents of the radiopharmaceutical injection medicine, such as thallous chloride [Tl-201] (6mL). It takes TlCl [Tl-201] as an example to present its novelty and productivity in the embodiment of the present invention. The pharmacy will maintain its stability and constant quality, and in conformance to its physical and chemical property at isotonic state and pH value 6.5. After the formulation of the pharmaceutical solvent being completed, the relative standard deviation is (RSD %)≦1% at calibration time.

Table 1 indicates the parameters inputted in the process and Table 2 indicates the output datum generated by the formula of the present invention taking Tl-201 injection pharmacy as an example. After input of parameters in Table 1, the output datum are obtained through calculation with the formulas (1)˜(7) and listed in table 2. Accurate preparation solvent can be produced using the output datum in table 2 and dispensed to each individual sterile bottle. The actual measurement of activity of the product can be compared with the theoretical calculation through the formulas of the present invention for evaluation.

TABLE 1

| Production | Production | Calibration | Expired | | T1-200 |
|---|---|---|---|---|---|
| No. | date | time | date | T1-200% | time |
| T08001A | 2008/1/2 | 2008/1/4 | 2008/1/7 | 0.0013 | 2008/1/2 |
| | 10:00 | 17:00 | | | 10:00 |

| Activity | Volume | | Measurement |
|---|---|---|---|
| (A0-mCi) | (Vo-mL) | pH of extract | time (Tm) |
| 373 | 3.62 | 5.3 | 2008/1/2 |
| | | | 10:00 |

TABLE 2

| Tc-Tm | | | | | Vb |
|---|---|---|---|---|---|
| (hr) | Coefficient-X | Coefficient-Y | Coefficient-F | Vf mL | mL |
| 55 | 0.595304902 | 16.12619006 | 0.997822115 | 134.89 | 1.24 |

| | | Theoretical | Activity of |
|---|---|---|---|
| Vn mL | Vj mL | pH of product | product |
| 115.39 | 18.25 | 5.2 | 16.1 |

What is claimed is:

1. A method for automated formulation process and evaluation of a radiopharmaceutical injection medicine comprising:
(a) Steps of preparation process:
measuring radioactivity of radiopharmaceutical materials;
measuring volume of radiopharmaceutical materials;
determining measurement time of radioactivity;
determining calibration time of radiopharmaceutical injection;
measuring pH value of radiopharmaceutical materials;
measuring the percentage of impurities of radionuclide;
(b) Steps of calculation and measurement for formulation control comprising:
calculating coefficient X, Y, and F for preparation;
calculating volume of benzyl alcohol;
calculating volume of saline;
calculating volume of injection solvent;
measuring pH value of mixed product;
(c) Repeat steps (a) and steps (b) until the pH value reach 6.5;
(d) Mix the radiopharmaceutical materials with the volume in step (a) and the solvent in step (b) with volumes of V_{b}, Vₙ, Vⱼ to produce finish product;
(e) Dispensing the product into sterile bottles.

2. A method according to claim 1, the coefficient X is calculated by:
X=EXP (−(LN(2)/73.5)×(Tc−Tm)), wherein Tc is calibration time and Tm is measurement time.

3. A method according to claim 1, the volume of benzyl alcohol is V_{b}=(0.99 Vₒ+V_{f})×0.009, wherein Vₒ indicates the volume of the radiopharmaceutical materials, and V_{f} indicates total volume of benzyl alcohol preparation solvent.

4. A method according to claim 1, the volume of saline is Vₙ=(0.99 Vₒ+Vf)×0.8333, wherein Vₒ indicates the volume of the radiopharmaceutical materials and V_{f} indicates the total volume of preparation solvent.

5. A method according to claim 1, the total volume of preparation solvent is V_{f}=(A₀F/Y)×6−0.99 Vₒ, wherein A₀ indicates the radioactivity, Vₒ indicates the volume of the radiopharmaceutical materials, F indicates the correction function of the impurities of the nuclide, and Y indicates the activity of the product of each bottle at calibration time.
